(19) United States
(12) Patent Application Publication
(10) Pub. No.: US 2017/0329489 A1
(43) Pub. Date: Nov. 16, 2017

(54) OPERATION INPUT APPARATUS, MOBILE TERMINAL, AND OPERATION INPUT METHOD

(71) Applicant: KYOCERA Document Solutions Inc., Osaka (JP)

(72) Inventor: Hiroki Arakawa, Osaka (JP)

(21) Appl. No.: 15/589,811

(22) Filed: May 8, 2017

(30) Foreign Application Priority Data
May 11, 2016 (JP) 2016-095105

(51) Int. Cl. G06F 3/0481; G06T 3/20; G06F 3/0488; G06F 3/0482; G06F 3/041; G06T 3/40; G06F 3/0346

(52) U.S. Cl. CPC G06F 3/04817; G06T 3/40; G06T 3/20; G06F 3/0346; G06F 3/0482; G06F 3/041; G06F 3/0488

(57) ABSTRACT

An operation input apparatus includes a display, a touch panel, a tilt detector, a display controller, and an operation detector. The touch panel is provided on the display. The tilt detector detects a tilt direction and a tilt amount of the display. The display controller moves a plurality of icons displayed on the display, in a direction corresponding to the tilt direction detected by the tilt detector, by a movement amount corresponding to the tilt amount detected by the tilt detector. The operation detector detects a selection operation performed, via the touch panel, on one of the plurality of icons that have been moved by the display controller.

### INCORPORATION BY REFERENCE

This application is based upon and claims the benefit of priority from the corresponding Japanese Patent Application No. 2016-095105 filed on May 11, 2016, the entire contents of which are incorporated herein by reference.

### BACKGROUND

The present disclosure relates to an operation input apparatus, a mobile terminal, and an operation input method, the operation input apparatus including a touch panel.

Among operation input apparatuses that include a display portion and a touch panel provided on the display portion, there are ones whose touch panel can be operated by the user with a thumb of his/her hand holding the operation input apparatus.

However, since the thumb of the hand holding the operation input apparatus has a limited range of reach, in case the display portion has of a large screen, the user has to use the other hand to touch an icon or the like displayed in an upper portion of the display portion.

It is noted that there is known an apparatus that moves icons displayed on the screen when an operation of changing the attitude of the apparatus is performed. In that apparatus, for example, when the user rotationally moves the apparatus while holding the lower right portion of the apparatus such that the upper left portion of the apparatus comes closer to the user, and then goes away from the user, a plurality of icons on the screen are moved toward the lower right of the screen and displayed in a lower-right area of the screen.

### SUMMARY

An operation input apparatus according to an aspect of the present disclosure includes a display, a touch panel, a tilt detector, a display controller, and an operation detector. The touch panel is provided on the display. The tilt detector detects a tilt direction and a tilt amount of the display. The display controller moves a plurality of icons displayed on the display, in a direction corresponding to the tilt direction detected by the tilt detector, by a movement amount corresponding to the tilt amount detected by the tilt detector. The operation detector detects a selection operation performed, via the touch panel, on one of the plurality of icons that have been moved by the display controller.

A mobile terminal according to another aspect of the present disclosure includes the operation input apparatus and a process executing part. The process executing part executes a process corresponding to the one of the plurality of icons on which the selection operation was performed.

An operation input method according to a further aspect of the present disclosure includes a detection step, a display control step, and an operation detection step. In the detection step, a tilt direction and a tilt amount of a display are detected. In the display control step, a plurality of icons displayed on the display are moved in a direction corresponding to the tilt direction detected in the detection step, by a movement amount corresponding to the tilt amount detected in the detection step. In the operation detection step, a selection operation performed via the touch panel on one of the plurality of icons that have been moved in the display control step, is detected.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing an outer appearance of a mobile terminal according to an embodiment of the present disclosure.

FIG. 2 is a block diagram showing a system configuration of the mobile terminal according to the embodiment of the present disclosure.

FIG. 3 is a diagram showing an example of a home screen in a normal mode displayed on the mobile terminal according to the embodiment of the present disclosure.

FIG. 4 is a diagram showing an example of the home screen in an icon movement mode displayed on the mobile terminal according to the embodiment of the present disclosure.

FIG. 5 is a diagram showing an example of the home screen in the icon movement mode displayed on the mobile terminal according to the embodiment of the present disclosure.

FIG. 6 is a diagram showing an example of the home screen in the icon movement mode displayed on the mobile terminal according to the embodiment of the present disclosure.

FIG. 7 is a diagram showing an example of the home screen in the icon movement mode displayed on the mobile terminal according to the embodiment of the present disclosure.

FIG. 8 is a diagram showing an example of the home screen in the icon movement mode displayed on the mobile terminal according to the embodiment of the present disclosure.

FIG. 9 is a diagram showing an example of the home screen in the icon movement mode displayed on the mobile terminal according to the embodiment of the present disclosure.

FIG. 10 is a diagram showing an example of the home screen in the icon movement mode displayed on the mobile terminal according to the embodiment of the present disclosure.

FIG. 11 is a flowchart showing an example of a procedure of an icon movement process executed in the mobile terminal according to the embodiment of the present disclosure.

FIG. 12 is a flowchart showing an example of a procedure of a rightward movement process executed in the mobile terminal according to the embodiment of the present disclosure.

FIG. 13 is a flowchart showing an example of a procedure of a leftward movement process executed in the mobile terminal according to the embodiment of the present disclosure.

FIG. 14 is a flowchart showing an example of a procedure of a downward movement process executed in the mobile terminal according to the embodiment of the present disclosure.

### DETAILED DESCRIPTION

The following describes an embodiment of the present disclusure with reference to the accompanying drawings. It should be noted that the following embodiment is an example of a specific embodiment of the present disclosure and should not limit the technical scope of the present disclosure.

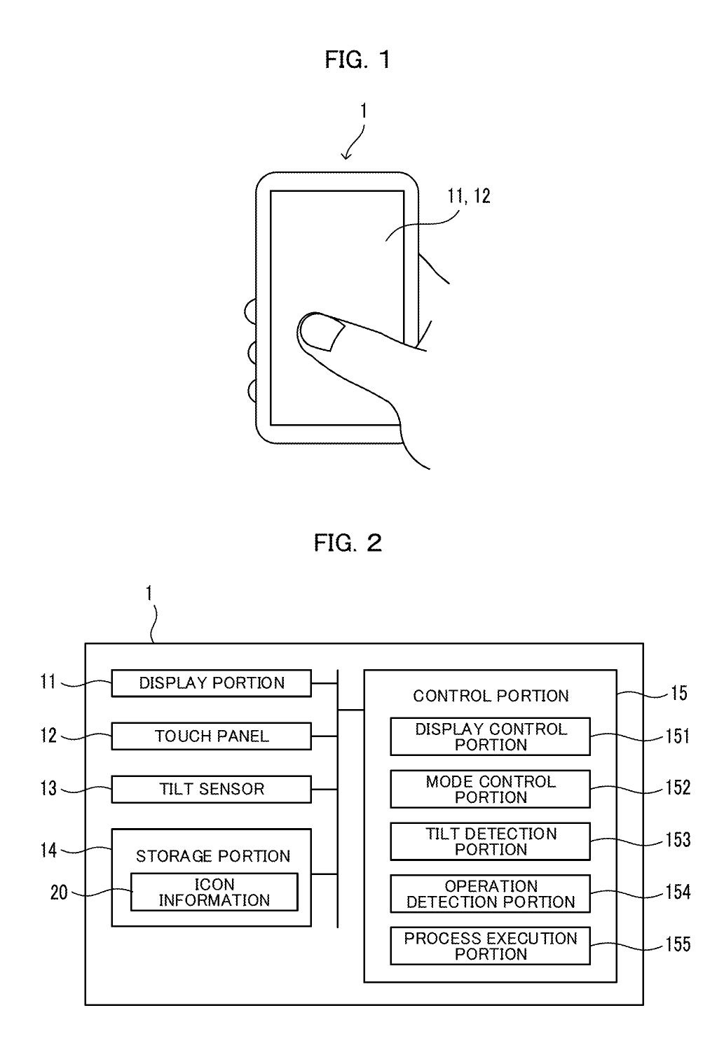

As shown in FIG. 1 and FIG. 2, a mobile terminal 1 according to an embodiment of the present disclosure includes a display portion 11 (a display), a touch panel 12, a tilt sensor 13, a storage portion 14, and a control portion 15.

The display portion 11 is, for example, a liquid crystal display, and displays a home screen and the like. The touch panel 12 is provided on the display portion 11, and detects a touch position of the user.

The user can hold the mobile terminal 1 with one or both of his/her hands, and can operate the touch panel 12 with a thumb of his/her hand holding the mobile terminal 1. The mobile terminal 1 is, for example, a tablet PC, a smartphone, an electronic book reader, or a mobile information terminal. The mobile terminal 1 may be an input device that is used by the user to operate another apparatus connected to the mobile terminal 1.

The tilt sensor 13 is configured to detect a tilt direction and a tilt amount of the display portion 11. The tilt sensor 13 is, for example, an acceleration sensor or a gyro sensor.

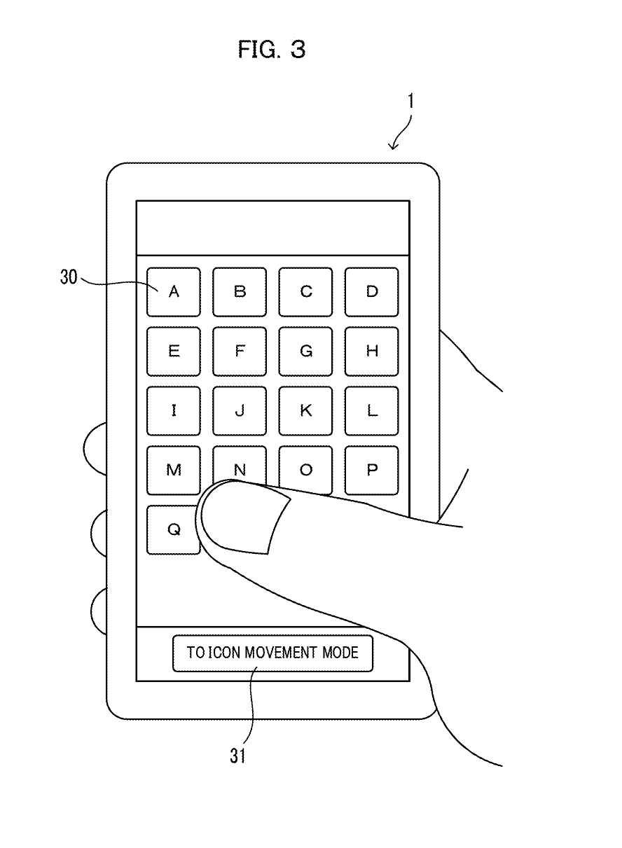

The storage portion 14 is a nonvolatile storage portion. The storage portion 14 stores various control programs executed by the control portion 15, image data of a plurality of icons 30 (see FIG. 3) displayed on the display portion 11, icon information 20 that includes the display position and size of each of the icons 30, and the like.

The control portion 15 includes control equipment such as CPU, ROM, and RAM. The CPU is a processor that executes various calculation processes. The ROM is a nonvolatile storage portion in which various information such as control programs for causing the CPU to execute various processes are stored in advance. The RAM is a volatile or nonvolatile storage portion that is used as a temporary storage memory (working area) for the various processes executed by the CPU.

Specifically, the control portion 15 includes a display control portion 151 (a display controller), a mode control portion 152 (a mode controller), a tilt detection portion 153 (a tilt detector), an operation detection portion 154 (an operation detector), and a process execution portion 155 (a process executing part). It is noted that the control portion 15 functions as these processing portions when it executes various processes in accordance with the control programs. In addition, the control portion 15 may include an electronic circuit that realizes part or all of processing functions of the processing portions.

The display control portion 151 displays various types of screen, such as a home screen, on the display portion 11. The display control portion 151 displays, for example, a home screen that includes a plurality of icons 30 on the display portion 11 (see FIG. 3), based on the image data of the icons 30 and the icon information 20 stored in the storage portion 14 or the ROM.

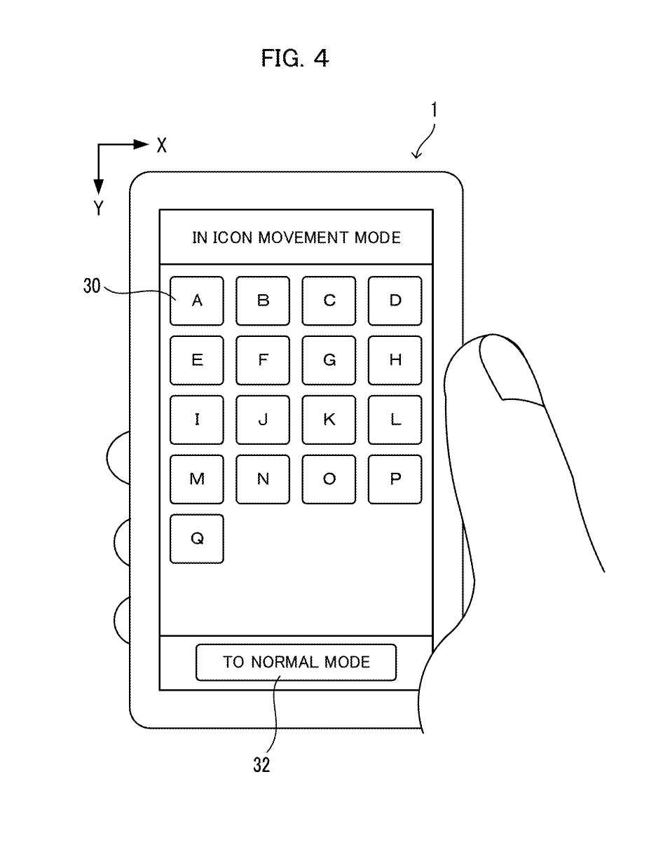

The mode control portion 152, in response to a user operation, switches the display mode of the icons 30 between a normal mode and an icon movement mode. In the icon movement mode, with a tilt of the display portion 11, the icons 30 are moved (see FIG. 4 to FIG. 10). In the normal mode, the icons 30 are displayed at predetermined initial positions regardless of the tilt of the display portion 11 (see FIG. 3).

The tilt detection portion 153 detects a tilt direction and a tilt amount of the display portion 11 based on a detection signal from the tilt sensor 13. For example, the tilt detection portion 153 detects how many degrees the display portion 11 is tilted for each of the rightward, leftward, and downward directions.

In the icon movement mode, the display control portion 151 moves the plurality of icons 30 in the tilt direction detected by the tilt detection portion 153, by a movement amount corresponding to the tilt amount detected by the tilt detection portion 153 (see FIG. 4 to FIG. 10).

The operation detection portion 154 detects a selection operation performed on one of the plurality of icons 30 via the touch panel 12. The selection operation is, for example, tapping (or double-tapping) a desired icon 30 with a finger, or separating a finger from a desired icon 30. It is noted that when the icons 30 have been moved by the display control portion 151 before the selection operation is performed, the operation detection portion 154 detects the selection operation performed via the touch panel 12 on one of the icons 30 that have been moved by the display control portion 151.

The process execution portion 155 executes a process corresponding to the icon 30 on which the selection operation was performed. For example, when an icon 30 associated with a specific application program is tapped, the process execution portion 155 executes the application program.

Next, the operation of the mobile terminal 1 is described with reference to FIG. 3 to FIG. 10. The following describes, as one example, the operation of the mobile terminal 1 when the home screen is displayed on the display portion 11.

FIG. 3 shows an example of the home screen in the normal mode. As shown in FIG. 3, a plurality of icons 30 and a mode change button 31 are displayed on the home screen in the normal mode. On the home screen shown in FIG. 3, 17 (seventeen) icons 30 are displayed. Individual images of the icons 30 may be displayed in a distinguishable manner. However, in FIG. 3 to FIG. 10, alphabets “A” to “Q” representing the individual icons 30 are displayed instead for the sake of convenience. In the following description, an icon 30 with alphabet “A” may be referred to as “icon A”. This also applies to icons 30 with alphabets “B” to “Q”. The mode change button 31 is used for starting the icon movement mode.

When the operation detection portion 154 detects that the user performed the selection operation on any of the icons 30 on the home screen, the process execution portion 155 executes the process corresponding to the icon 30 on which the selection operation was performed.

As shown in FIG. 3, the user can operate the touch panel 12 by using a thumb of his/her hand while holding the mobile terminal 1 with that hand. However, since the thumb of his/her hand holding the mobile terminal 1 has a limited range of reach, in case the display portion 11 has a large screen, the user has to use the other hand to touch an icon (for example, the icon A shown in FIG. 3) located in an upper portion of the display portion 11.

It is noted that there is known an apparatus that moves the icons displayed on the screen when an operation of changing the attitude of the apparatus is performed. In that apparatus, for example, when the user rotationally moves the apparatus while holding the lower right portion of the apparatus such that the upper left portion of the apparatus comes closer to the user, and then goes away from the user, the plurality of icons on the screen move toward the lower right of the screen and are displayed in a lower-right area of the screen. However, according to this apparatus, the user cannot control a movement amount of the icons. Accordingly, for example, as shown in FIG. 3, when a lot of icons 30 are displayed on the screen, even if the icons 30 are moved to the lower-right area of the screen, the thumb of his/her hand holding the apparatus may not reach a desired icon 30.

On the other hand, according to the mobile terminal 1 of the present embodiment, as described in the following, the plurality of icons 30 displayed on the display portion 11 are moved in the tilt direction detected by the tilt detection portion 153 by a movement amount corresponding to the tilt amount detected by the tilt detection portion 153. This makes it possible to move the icons 30 displayed on the screen intuitively by a desired movement amount.

In FIG. 3, when a desired icon 30 is displayed at a position where the thumb of his/her right hand cannot touch, the user can change the display mode from the normal mode to the icon movement mode, as necessary. There may be provided some ways for changing the display mode from the normal mode to the icon movement mode. For example, the mode control portion 152 may change the display mode from the normal mode to the icon movement mode in response to a touch of the mode change button 31 displayed on the display portion 11. Alternatively, the mode control portion 152 may change the display mode from the normal mode to the icon movement mode when a sensor such as an acceleration sensor has detected the user shaking the mobile terminal 1.

After a change of the display mode to the icon movement mode, the display control portion 151, as shown in FIG. 4, may display, on the display portion 11, an indication that the mobile terminal 1 is in the icon movement mode. In addition, the display control portion 151 may display, on the display portion 11, a mode change button 32 that is used to end the icon movement mode.

In the icon movement mode, the user can move the plurality of icons 30 displayed on the display portion 11 toward a desired direction by tilting the display portion 11 (namely, the mobile terminal 1) toward a desired direction. Furthermore, the user can change the movement amount of the icons 30 by changing the tilt amount of the display portion 11.

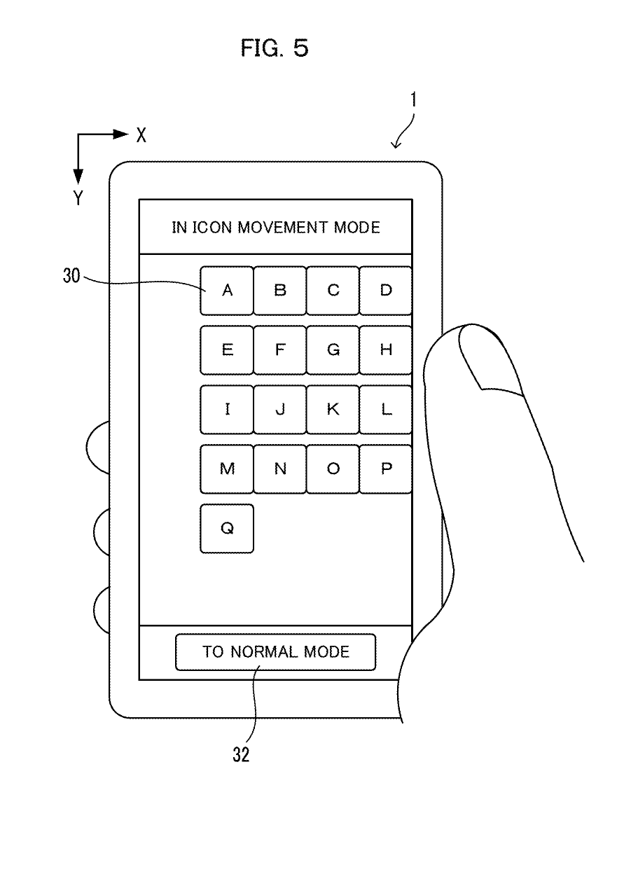

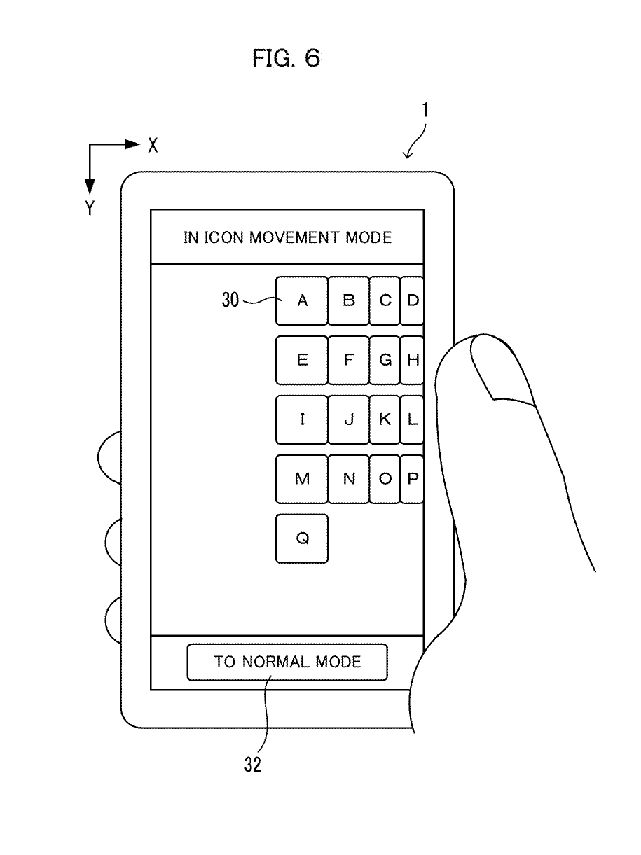

First, the operation of the mobile terminal 1 when the mobile terminal 1 is tilted rightward is described with reference to FIG. 5 and FIG. 6.

When the tilt detection portion 153 detects that the mobile terminal 1 was tilted rightward a little (for example, when the tilt amount of the display portion 11 tilted rightward is equal to or larger than a first threshold and smaller than a second threshold), the display control portion 151 brings the plurality of icons 30 closer to the right end of the screen of the display portion 11, as shown in FIG. 5.

It is noted that in the icon movement mode, desirably the display control portion 151 moves the plurality of icons 30 in a state where the arrangement of the icons 30 is maintained. For example, the icon Q is located under the icon M in FIG. 3. Accordingly, the display control portion 151 moves the plurality of icons 30 closer to the right end of the screen in a state where the icon Q is located under the icon M. With this configuration, when the plurality of icons 30 are moved in the icon movement mode, the arrangement thereof in the normal mode is maintained. This provides substantially the same operation feeling as in the normal mode to the user, enabling the user to select a desired icon 30 easily.

As shown in FIG. 5, after the plurality of icons 30 are brought closer to the right end of the screen, the user can touch, for example, the icon M that he/she could not touch in the state shown in FIG. 3.

In addition, when the tilt detection portion 153 detects that the mobile terminal 1 was tilted rightward largely (for example, when the tilt amount of the display portion 11 tilted rightward is equal to or larger than the second threshold), the display control portion 151 reduces the plurality of icons 30 in size in the left-right direction and brings the icons 30 in that state closer to the right end of the screen of the display portion 11, as shown in FIG. 6.

For reducing the plurality of icons 30 in size, the display control portion 151 may reduce them with the same reduction ratio. Alternatively, the display control portion 151 may reduce them with the reduction ratios that correspond to the distances from the right end of the screen.

Specifically, as shown in FIG. 6, the display control portion 151 desirably reduces the icons in size such that the closer to the right end of the screen an icon is, the smaller the icon is. When the mobile terminal 1 is tilted largely rightward, it means that the user intends to select an icon 30 that is far away from the right end of the screen (for example, the icon I shown in FIG. 6). When the icons are reduced in size such that the closer to the right end of the screen an icon is, the smaller the icon is, an icon 30 located far away from the right end can be made closer to the right end, with its original size maintained (or hardly reduced). This makes it possible to select a desired icon 30 easily.

It is noted that any of the icons 30 located close to the right end of the screen (for example, the icon L and the like) is not considered to be the desired icon 30 that the user intends to select. Thus, even if such an icon is reduced in size and becomes difficult to touch, the operability is not substantially degraded.

As shown in FIG. 6, after the plurality of icons 30, reduced in size in the left-right direction, are brought closer to the right end of the screen, the user can touch, for example, the icon I that the user could not touch with the thumb of his/her right hand in the state shown in FIG. 5.

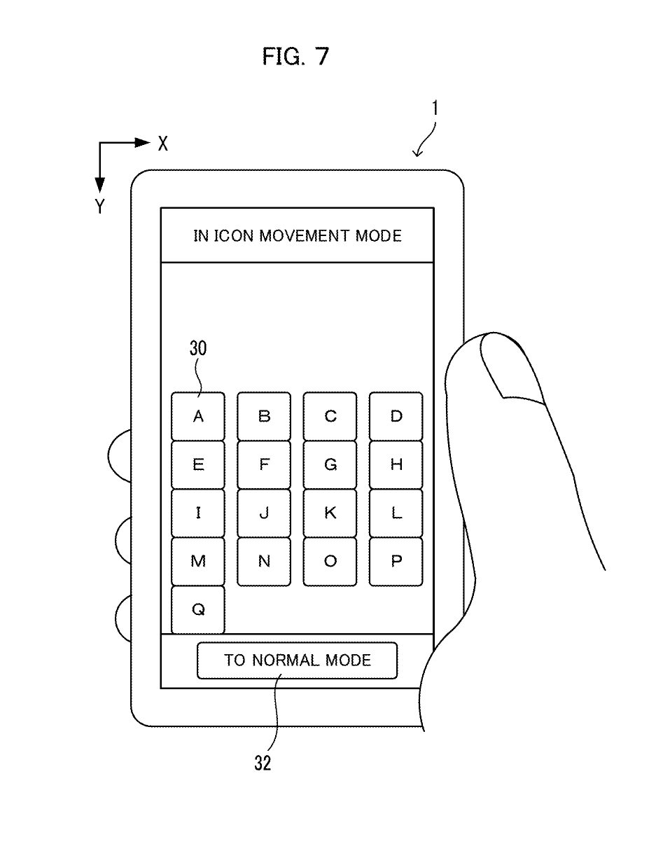

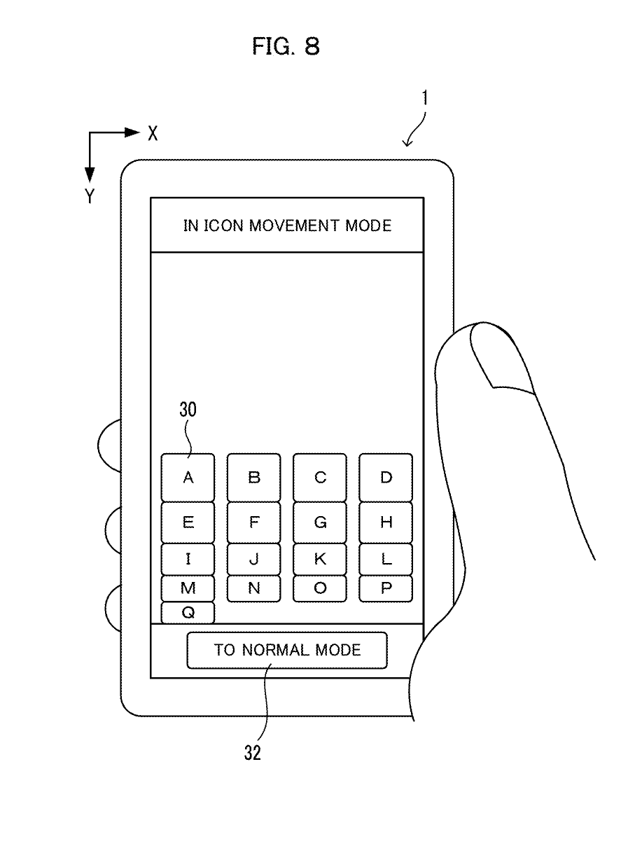

Next, the operation of the mobile terminal 1 when the mobile terminal 1 is tilted downward is described with reference to FIG. 7 and FIG. 8.

When the tilt detection portion 153 detects that the mobile terminal 1 was tilted downward a little (for example, when the tilt amount of the display portion 11 tilted downward is equal to or larger than the first threshold and smaller than the second threshold), the display control portion 151 brings the plurality of icons 30 closer to the lower end of the screen of the display portion 11, as shown in FIG. 7. This makes it possible for the user to touch, for example, the icon G that the user could not touch with the thumb of his/her right hand in the state shown in FIG. 3.

When the tilt detection portion 153 detects that the mobile terminal 1 was tilted downward largely (for example, when the tilt amount of the display portion 11 tilted downward is equal to or larger than the second threshold), the display control portion 151 brings the plurality of icons 30 closer to the lower end of the screen of the display portion 11 in a state where the icons 30 are reduced in size in the up-down direction, as shown in FIG. 8. This makes it possible for the user to touch, for example, the icon B that the user could not touch with the thumb of his/her right hand in the state shown in FIG. 7. In this case, too, as shown in FIG. 8, the display control portion 151 desirably reduces the icons in size such that the closer to the lower end of the screen an icon is, the smaller the icon is.

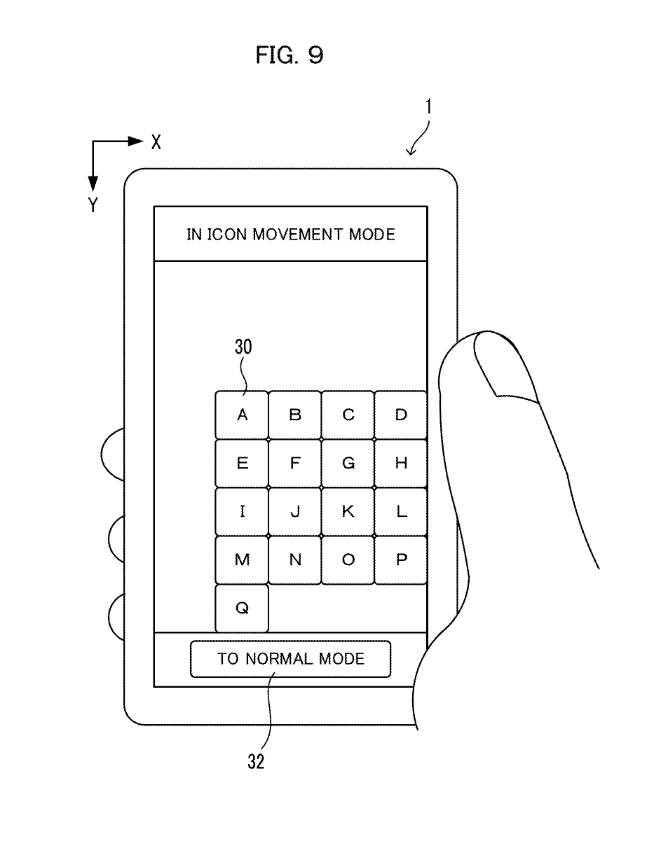

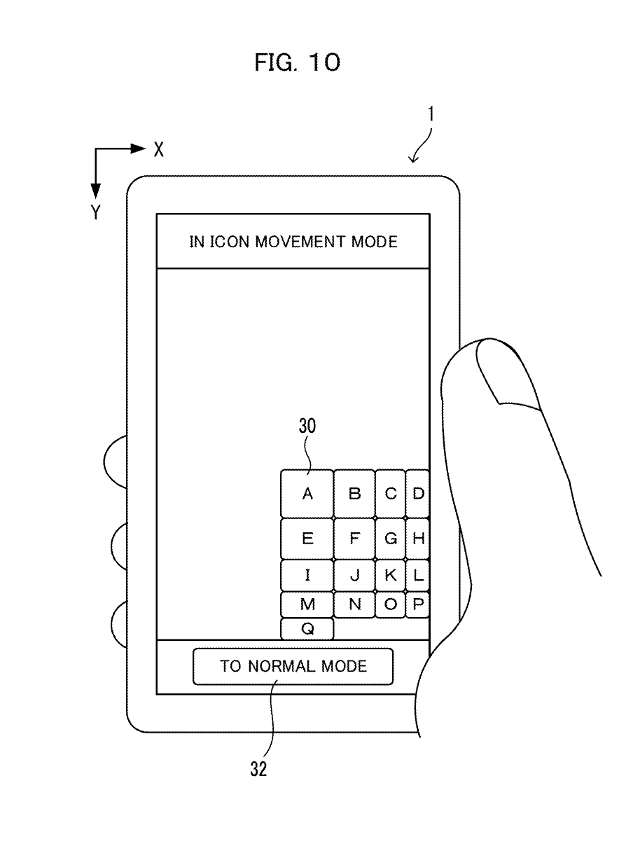

Next, the operation of the mobile terminal 1 when the mobile terminal 1 is tilted toward the lower right is described with reference to FIG. 9 and FIG. 10.

When the tilt detection portion 153 detects that the mobile terminal 1 was tilted toward the lower right a little (for example, when the tilt amount of the display portion 11 tilted rightward is equal to or larger than the first threshold and smaller than the second threshold, and the tilt amount of the display portion 11 tilted downward is equal to or larger than the first threshold and smaller than the second threshold), the display control portion 151 brings the plurality of icons 30 closer to the lower right end of the screen of the display portion 11, as shown in FIG. 9. This makes it possible for the user to touch, for example, the icon F that the user could not touch with the thumb of his/her right hand in the state shown in FIG. 3.

When the tilt detection portion 153 detects that the mobile terminal 1 was tilted toward the lower right largely (for example, the tilt amount of the display portion 11 tilted rightward is equal to or larger than the second threshold, and the tilt amount of the display portion 11 tilted downward is equal to or larger than the second threshold), the display control portion 151 brings the plurality of icons 30 closer to the lower end of the screen of the display portion 11 in a state where the icons 30 are reduced in size in the left-right direction and the up-down direction, as shown in FIG. 10. This makes it possible for the user to touch, for example, the icon A that the user could not touch with the thumb of his/her right hand in the state shown in FIG. 9. In this case, too, as shown in FIG. 10, the display control portion 151 desirably reduces the icons in size such that the closer to the right end of the screen an icon is, the smaller the icon is, and the closer to the lower end of the screen an icon is, the smaller the icon is.

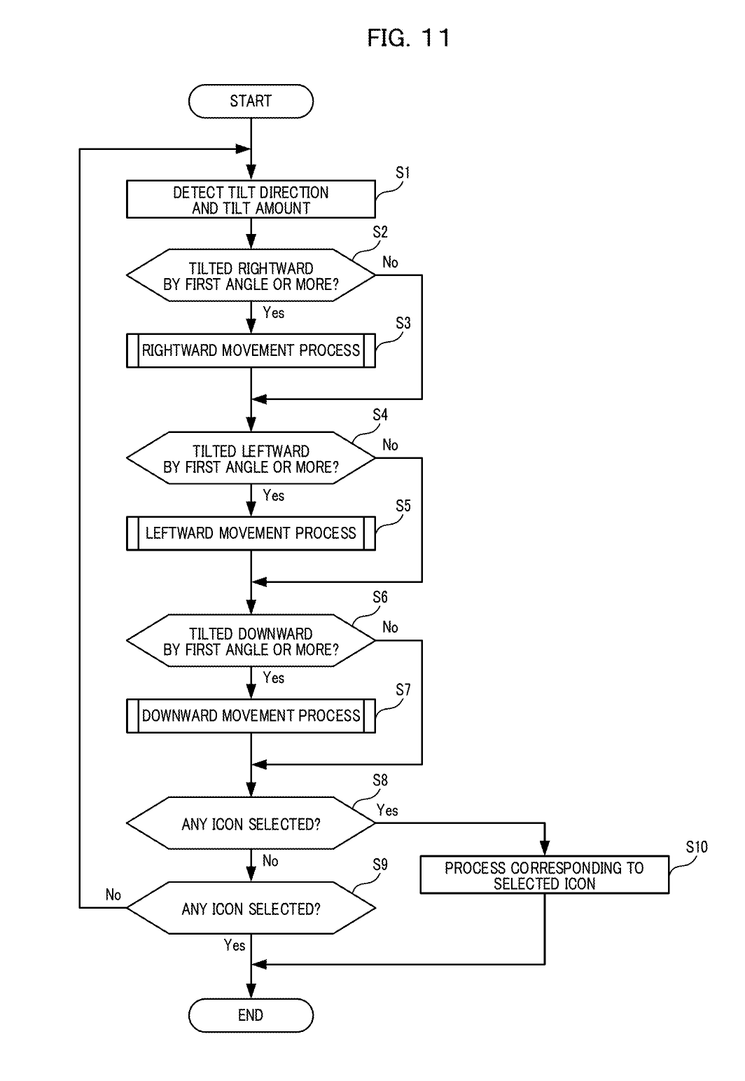

In the following, an example of the procedure of the icon movement process executed by the control portion 15 is described with reference to FIG. 11 to FIG. 14. Here, steps S1, S2, . . . represent numbers assigned to the processing procedures (steps) executed by the control portion 15. It is noted that the icon movement process is started when the icon movement mode is started by the mode control portion 152.

<Step S1>

First, in step S1, the control portion 15 detects the tilt direction and the tilt amount of the display portion 11 based on the detection signal from the tilt sensor 13. Here, as shown in FIG. 4, the coordinate axis extending along the left-right direction of the display portion 11 is defined as X axis, and the coordinate axis extending along the up-down direction of the display portion 11 is defined as Y axis. Under these conditions, the control portion 15 may detect the angle between the X axis and the horizontal surface as the tilt amount of the display portion 11 in the left-right direction, and detect the angle between the Y axis and the horizontal surface as the tilt amount of the display portion 11 in the up-down direction, for example. Alternatively, a plane extending along the screen of the display portion 11 at the start of the icon movement mode may be defined as a reference plane, and the control portion 15 may detect, as the tilt amount of the display portion 11 in the left-right direction, the angle between the X axis and the reference plane, and detect, as the tilt amount of the display portion 11 in the up-down direction, the angle between the Y axis and the reference plane.

<Step S2>

In step S2, the control portion 15 determines, based on the detection result of step S1, whether or not the display portion 11 is tilted rightward by a first angle (for example, five degrees) or more. When it is determined that the display portion 11 is tilted rightward by the first angle or more (S2: Yes), the process moves to step S3. On the other hand, when it is determined that the display portion 11 is not tilted rightward by the first angle or more (S2: No), the process moves to step S4. It is noted that the first angle may be changed in response to a user operation.

<Step S3>

In step S3, the control portion 15 executes a rightward movement process. Details of the rightward movement process are described below.

<Step S4>

In step S4, the control portion 15 determines, based on the detection result of step S1, whether or not the display portion 11 is tilted leftward by the first angle or more. When it is determined that the display portion 11 is tilted leftward by the first angle or more (S4: Yes), the process moves to step S5. On the other hand, when it is determined that the display portion 11 is not tilted leftward by the first angle or more (S4: No), the process moves to step S6.

<Step S5>

In step S5, the control portion 15 executes a leftward movement process. Details of the leftward movement process are described below.

<Step S6>

In step S6, the control portion 15 determines, based on the detection result of step S1, whether or not the display portion 11 is tilted downward by the first angle or more. When it is determined that the display portion 11 is tilted downward by the first angle or more (S6: Yes), the process moves to step S7. On the other hand, when it is determined that the display portion 11 is not tilted downward by the first angle or more (S6: No), the process moves to step S8.

<Step S7>

In step S7, the control portion 15 executes a downward movement process. Details of the downward movement process are described below.

<Step S8>

In step S8, the control portion 15 determines whether or not any of the icons 30 displayed on the display portion 11 has been selected by the selection operation performed via the touch panel 12. When it is determined that any of the icons 30 has been selected (S8: Yes), the process moves to step S10. On the other hand, when it is determined that any of the icons 30 has not been selected (S8: No), the process moves to step S9.

<Step S9>

In step S9, the control portion 15 determines whether or not the icon movement mode was ended. Specifically, the control portion 15 may determine that the icon movement mode was ended, when, for example, it is detected that the mode change button 32 that is used to end the icon movement mode, was touched. Alternatively, the control portion 15 may determine that the icon movement mode was ended, when, for example, when a sensor such as an acceleration sensor detects that the mobile terminal 1 was shaken by the user. When it is determined that the icon movement mode was ended (S9: Yes), the control portion 15 ends the icon movement mode and returns to the normal mode. This ends the icon movement process. On the other hand, when it is determined that the icon movement mode has not been ended (S9: No), the process returns to step S1.

<Step S10>

In step S10, the control portion 15 executes a process corresponding to the selected icon 30. Thereafter, the control portion 15 ends the icon movement mode and returns to the normal mode. This ends the icon movement process.

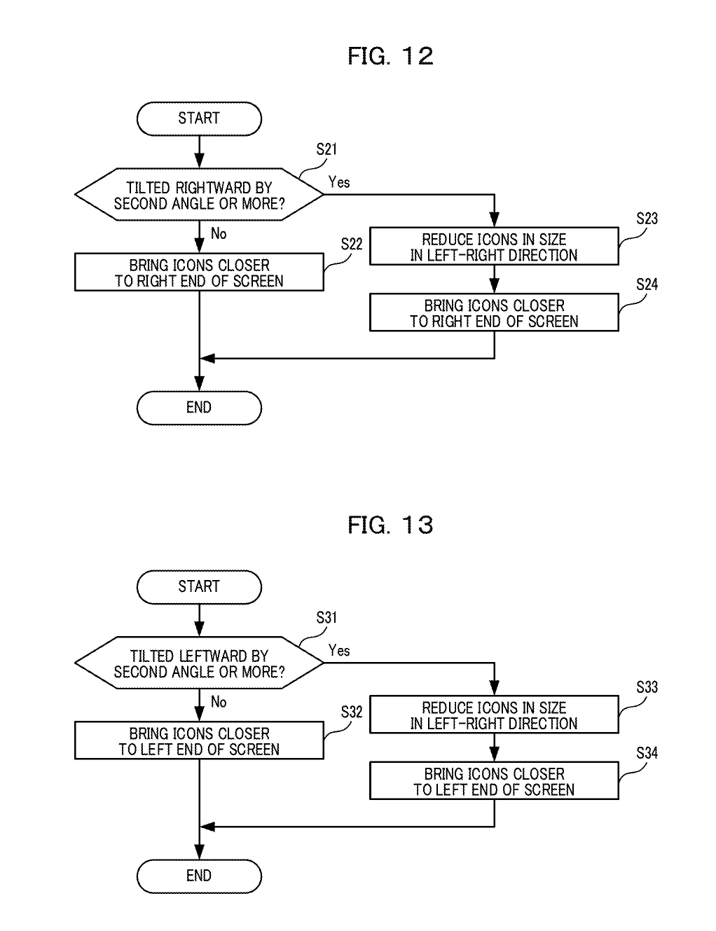

Next, the rightward movement process executed in the step S3 is described in detail with reference to FIG. 12.

<Step S21>

In step S21, the control portion 15 determines, based on the detection result of step S1, whether or not the display portion 11 is tilted rightward by a second angle (for example, 20 degrees) or more. When it is determined that the display portion 11 is tilted rightward by the second angle or more (S21: Yes), the process moves to step S23. On the other hand, when it is determined that the display portion 11 is not tilted rightward by the second angle or more (S21: No), the process moves to step S22. It is noted that the second angle may be changed in response to a user operation.

<Step S22>

In step S22, the control portion 15 brings the plurality of icons 30 closer to the right end of the screen. Specifically, the control portion 15 updates the X coordinate values of the two-dimensional coordinate that indicates the display positions of the icons 30 such that the icons 30 are brought closer to the right end of the screen. For example, the control portion 15 updates the X coordinate values of the icons 30 based on, for example, the sizes of the icons 30 in the left-right direction, or the intervals between the icons 30 in the left-right direction. At this time, for example, the control portion 15 updates the X coordinate values such that a plurality of icons 30 aligned in the same column (for example, the icons A, E, I, M and Q in FIG. 4) have a common X coordinate value. This ends the rightward movement process, and the process moves to the step S4 (FIG. 11).

<Step S23>

In step S23, the control portion 15 reduces the icons 30 in size in the left-right direction. Specifically, the control portion 15 updates the sizes (display sizes) of the icons 30 in the left-right direction such that the icons 30 are reduced in size in the left-right direction. At this time, the control portion 15 updates the sizes of the icons 30 in the left-right direction such that the closer to the right end of the screen an icon is, the smaller the icon is.

<Step S24>

In step S24, the control portion 15 brings the icons 30 closer to the right end of the screen. Specifically, the control portion 15 updates the X coordinate values of the two-dimensional coordinate that indicates the display positions of the icons 30 such that the icons 30 are brought closer to the right end of the screen. For example, the control portion 15 updates the X coordinate values of the icons 30 based on, for example, the sizes of the icons 30 in the left-right direction after the update in the step S23, or the intervals between the icons 30 in the left-right direction after the update in the step S23. At this time, for example, the control portion 15 updates the X coordinate values such that a plurality of icons 30 aligned in the same column (for example, the icons A, E, I, M and Q in FIG. 4) have a common X coordinate value. This ends the rightward movement process, and the process moves to the step S4 (FIG. 11).

Next, the leftward movement process executed in the step S5 is described in detail with reference to FIG. 13.

<Step S31>

In step S31, the control portion 15 determines, based on the detection result of step S1, whether or not the display portion 11 is tilted leftward by the second angle or more. When it is determined that the display portion 11 is tilted leftward by the second angle or more (S31: Yes), the process moves to step S33. On the other hand, when it is determined that the display portion 11 is not tilted leftward by the second angle or more (S31: No), the process moves to step S32.

<Step S32>

In step S32, the control portion 15 brings the plurality of icons 30 closer to the left end of the screen. Specifically, the control portion 15 updates the X coordinate values of the two-dimensional coordinate that indicates the display positions of the icons 30 such that the icons 30 are brought closer to the left end of the screen. For example, the control portion 15 updates the X coordinate values of the icons 30 based on, for example, the sizes of the icons 30 in the left-right direction, or the intervals between the icons 30 in the left-right direction. At this time, for example, the control portion 15 updates the X coordinate values such that a plurality of icons 30 aligned in the same column have a common X coordinate value. This ends the leftward movement process, and the process moves to the step S6 (FIG. 11).

<Step S33>

In step S33, the control portion 15 reduces the icons 30 in size in the left-right direction. Specifically, the control portion 15 updates the sizes (display sizes) of the icons 30 in the left-right direction such that the icons 30 are reduced in size in the left-right direction. At this time, the control portion 15 updates the sizes of the icons 30 in the left-right direction such that the closer to the left end of the screen an icon is, the smaller the icon is.

<Step S34>

In step S34, the control portion 15 brings the icons 30 closer to the left end of the screen. Specifically, the control portion 15 updates the X coordinate values of the two-dimensional coordinate that indicates the display positions of the icons 30 such that the icons 30 are brought closer to the left end of the screen. For example, the control portion 15 updates the X coordinate values of the icons 30 based on, for example, the sizes of the icons 30 in the left-right direction after the update in the step S33, or the intervals between the icons 30 in the left-right direction after the update in the step S33. At this time, for example, the control portion 15 updates the X coordinate values such that a plurality of icons 30 aligned in the same column have a common X coordinate value. This ends the leftward movement process, and the process moves to the step S6 (FIG. 11).

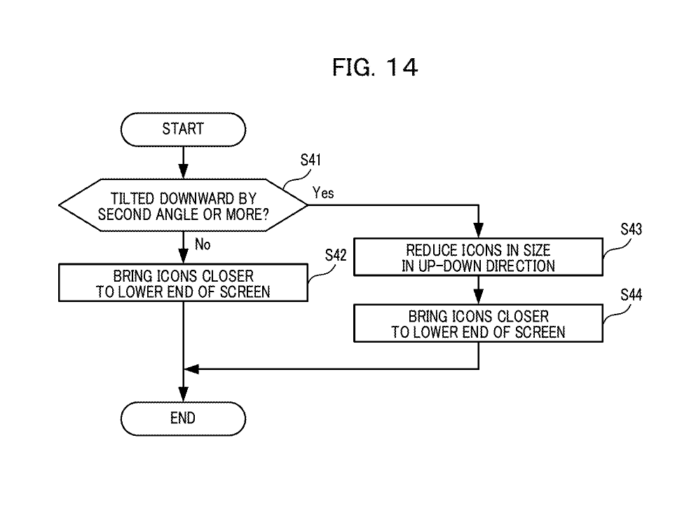

Next, the downward movement process executed in the step S7 is described in detail with reference to FIG. 14.

<Step S41>

In step S41, the control portion 15 determines, based on the detection result of step S1, whether or not the display portion 11 is tilted downward by the second angle (for example, 20 degrees) or more. When it is determined that the display portion 11 is tilted downward by the second angle or more (S41: Yes), the process moves to step S43. On the other hand, when it is determined that the display portion 11 is not tilted downward by the second angle or more (S41: No), the process moves to step S42. It is noted that the second angle may be changed in response to a user operation.

<Step S42>

In step S42, the control portion 15 brings the plurality of icons 30 closer to the lower end of the screen. Specifically, the control portion 15 updates the Y coordinate values of the two-dimensional coordinate that indicates the display positions of the icons 30 such that the icons 30 are brought closer to the lower end of the screen. For example, the control portion 15 updates the Y coordinate values of the icons 30 based on, for example, the sizes of the icons 30 in the up-down direction, or the intervals between the icons 30 in the up-down direction. At this time, for example, the control portion 15 updates the Y coordinate values such that a plurality of icons 30 aligned in the same row (for example, the icons M, N, O and P in FIG. 4) have a common Y coordinate value. This ends the downward movement process, and the process moves to the step S8 (FIG. 11).

<Step S43>

In step S43, the control portion 15 reduces the icons 30 in size in the up-down direction. Specifically, the control portion 15 updates the sizes (display sizes) of the icons 30 in the up-down direction such that the icons 30 are reduced in size in the up-down direction. At this time, the control portion 15 updates the sizes of the icons 30 in the up-down direction such that the closer to the lower end of the screen an icon is, the smaller the icon is.

<Step S44>

In step S44, the control portion 15 brings the icons 30 closer to the lower end of the screen. Specifically, the control portion 15 updates the Y coordinate values of the two-dimensional coordinate that indicates the display positions of the icons 30 such that the icons 30 are brought closer to the lower end of the screen. For example, the control portion 15 updates the Y coordinate values of the icons 30 based on, for example, the sizes of the icons 30 in the up-down direction after the update in the step S43, or the intervals between the icons 30 in the up-down direction after the update in the step S43. At this time, for example, the control portion 15 updates the Y coordinate values such that a plurality of icons 30 aligned in the same row (for example, the icons M, N, O and P in FIG. 4) have a common Y coordinate value. This ends the downward movement process, and the process moves to the step S8 (FIG. 11).

It is noted that the process of the step S1 (the tilt detection step) is executed by the tilt detection portion 153 of the control portion 15. The processes of the steps S2 to S7 (the display control step) are executed by the display control portion 151 of the control portion 15. The process of the step S8 (the operation detection step) is executed by the operation detection portion 154 of the control portion 15. The process of the step S10 is executed by the process execution portion 155 of the control portion 15.

As described above, according to the present embodiment, the plurality of icons 30 displayed on the display portion 11 are moved in a direction corresponding to the tilt direction of the display portion 11 by a movement amount corresponding to the tilt amount of the display portion 11. It is thus possible to move the icons 30 displayed on the screen, intuitively by a desired movement amount.

In the present embodiment, when the display portion 11 is tilted and the amount of the tilt is equal to or larger than the first threshold and smaller than the second threshold, the icons 30 are brought closer to an end of the screen, and when the amount of the tilt is equal to or larger than the second threshold, the icons 30 are reduced in size and brought closer to an end of the screen. However, the present disclosure is not limited to this configuration. As another embodiment, as the tilt amount of the display portion 11 increases, the display positions of the icons 30 may be controlled to be gradually moved toward an end of the screen. In addition, as the tilt amount of the display portion 11 increases, the icons 30 may be controlled to be gradually reduced in size and the display positions of the icons 30 may be controlled to be gradually moved toward an end of the screen.

In addition, according to the present embodiment, the icons 30 are moved in a state where the arrangement of the icons 30 is maintained. However, the present disclosure is not limited to the configuration. As another embodiment, in FIG. 5 and FIG. 6, the icon Q may be moved to a place under the icon P.

In addition, according to the present embodiment, when the icons 30 are moved, the intervals between the icons aligned along the movement direction are shortened. However, the present disclosure is not limited to the configuration. As another embodiment, the icons 30 may be controlled to be moved in a state where the intervals between the icons aligned along the movement direction are maintained.

In addition, according to the present embodiment, when the tilt amount of the display portion 11 is equal to or larger than the second threshold, the icons 30 are reduced in size and brought closer to an end of the screen. However, the present disclosure is not limited to the configuration. As another embodiment, when the tilt amount of the display portion 11 is equal to or larger than the second threshold, the icons 30 may be displayed such that icons aligned along the movement direction are partially overlapped with each other, without the sizes of the icons 30 being changed. In this case, with respect to two overlapping icons, an icon 30 on the upstream side in the movement direction is desirably displayed in front of an icon 30 on the downstream side.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An operation input apparatus comprising:
a display;
a touch panel provided on the display;
a tilt detector detecting a tilt direction and a tilt amount of the display;
a display controller moving a plurality of icons displayed on the display, in a direction corresponding to the tilt direction detected by the tilt detector, by a movement amount corresponding to the tilt amount detected by the tilt detector; and
an operation detector detecting a selection operation performed, via the touch panel, on one of the plurality of icons that have been moved by the display controller.

2. The operation input apparatus according to claim 1, wherein
when the tilt amount is equal to or larger than a first threshold and smaller than a second threshold, the display controller brings the plurality of icons closer to an end of a screen corresponding to the tilt direction, and when the tilt amount is equal to or larger than the second threshold, the display controller brings the plurality of icons closer to the end of the screen in a state where the icons are reduced in size in the direction corresponding to the tilt direction.

3. The operation input apparatus according to claim 2, wherein
the display controller reduces the plurality of icons in size with reduction ratios that correspond to distances from the end of the screen.

4. The operation input apparatus according to claim 3, wherein
the display controller reduces the plurality of icons in size such that the closer to the end of the screen an icon is, the smaller the icon is.

5. The operation input apparatus according to claim 1, wherein
the display controller moves the plurality of icons in a state where an arrangement of the plurality of icons is maintained.

6. The operation input apparatus according to claim 1, further comprising:
a mode controller switching a display mode of the plurality of icons between a normal mode and an icon movement mode, in response to a user operation, wherein
in the normal mode, the display controller displays the plurality of icons at predetermined initial positions, and in the icon movement mode, the display controller temporarily moves the plurality of icons by a movement amount corresponding to the tilt amount.

7. A mobile terminal comprising:
the operation input apparatus according to claim 1; and
a process executing part executing a process corresponding to the one of the plurality of icons on which the selection operation was performed.

8. An operation input method comprising:
a detection step of detecting a tilt direction and a tilt amount of a display;
a display control step of moving a plurality of icons displayed on the display, in a direction corresponding to the tilt direction detected in the detection step, by a movement amount corresponding to the tilt amount detected in the detection step; and
an operation detection step of detecting a selection operation performed via the touch panel on one of the plurality of icons that have been moved in the display control step.
